(19) United States
(12) Patent Application Publication
(10) Pub. No.: US 2006/0202387 A1
(43) Pub. Date: Sep. 14, 2006

(54) Method for producing a swab for cleaning the biopsy channel of an endoscope

(76) Inventors: Jean-Paul Durand, Saint Germain en Laye (FR); Alain Lloze, Amaye sur Orme (FR); Jacques Oblin, Cormelles le Royal (FR)

Correspondence Address: Dr. Ron Jacobs, 2345 Yale Street, 2nd Floor, Palo Alto, CA, 94306, US

(21) Appl. No.: 10/523,571

(22) PCT Filed: Jul. 29, 2003
(86) PCT No.: PCT/FR03/02395

§ 371 Date: Feb. 27, 2006

(30) Foreign Application Priority Data
Jul. 29, 2002 (FR) 02/09605

(51) Int. Cl. B29D 31/00

(52) U.S. Cl. 264/243

(57) ABSTRACT

The channel cleaning brush comprises a flexible core (10) on which at least one brush (15) is mounted, which is formed by a shaft (20) and a cleaning coil disposed on the shaft, which comprises fins (21) regularly disposed on the shaft (20). The brushes are over-moulded on the core.

The invention relates to endoscopes, more precisely to the operating channels of these endoscopes.

Endoscope operating channels make it possible to move biopsy pincers to the operating site in order to take tissue samples at that location.

The repeated passage of the biopsy pincers into the operating channels, and in particular the passage of the rigid elements of these devices into the curves formed by the channels once introduced into the human body, has damaging effects whereby they scrape the internal walls, create diverticula therein, perhaps cause perforations therein or even promote the creation of biofilms by coating the wall thereof, thus increasing the risks of contamination of the pincers before they arrive at the operating site.

In order to prevent these effects or risks, i.e. in order, after each usage, to remove the biofilm which may have been deposited, it is normal practice to use channel cleaning brushes which are small brushes with a handle in the fashion of those used domestically for cleaning bottles or other containers.

For such usage the brushes are formed by a group of synthetic material bristles and are attached to flexible “handles” or flexible cores which are sufficiently long to permit the brushes to pass from one end of the channels to the other.

Apart from the fact that the channel cleaning brushes are produced and packaged singly, their manufacture involves several production phases including at least the preparation of the cores and of the brushes, the mounting of the brushes onto the cores being carried out as a third stage followed by packaging of the channel cleaning brush.

In summary, these constraints make the operations of cleaning the operating channels expensive, especially since the channel cleaning brushes are thrown away after every use.

U.S. Pat. No. 5,964,004 discloses cleaners for tubes such as endoscope operating channels, and proposes blades on a sheath mounted on a flexible core, the blades and the sheath being integrally moulded on the flexible core and being made of rubber or synthetic material, the core being a steel wire.

WO01 28406 proposes the materials which can be used and the means of attaching the brush to the core which is a filament of extruded propylene onto which the brush is over-moulded.

The applicant has sought to provide a greater reduction in the manufacturing costs for channel cleaning brushes.

To this end the invention relates to a process for producing a channel cleaning brush (1) for cleaning an endoscope operating channel, comprising, mounted on a flexible core (10), at least one brush (15) comprising a cleaning coil (21) disposed on a shaft (20), wherein a synthetic material brush (15) is over-moulded (30′, 30″; 100) onto the core (10), the process being characterised by the fact that a plurality of brushes (15) are over-moulded onto the core (10).

The core is advantageously pre-cut between two brushes.

It is thus possible to cut the core between two brushes, to separate the two stands of the core and to over-mould a pre-cutting point connector comprising a breaking point between the two strands.

The invention will be better understood with the aid of the following description and of the accompanying drawing in which;

FIG. 1 is a simplified view of a channel cleaning brush in accordance with the invention,

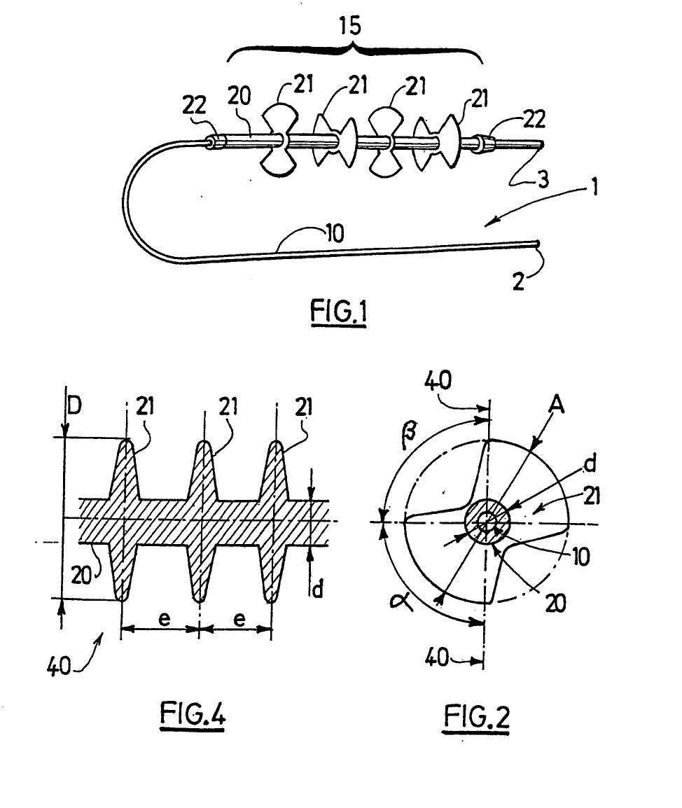

FIG. 2 shows a transverse cross-sectional view in front of the last fin of a channel cleaning brush,

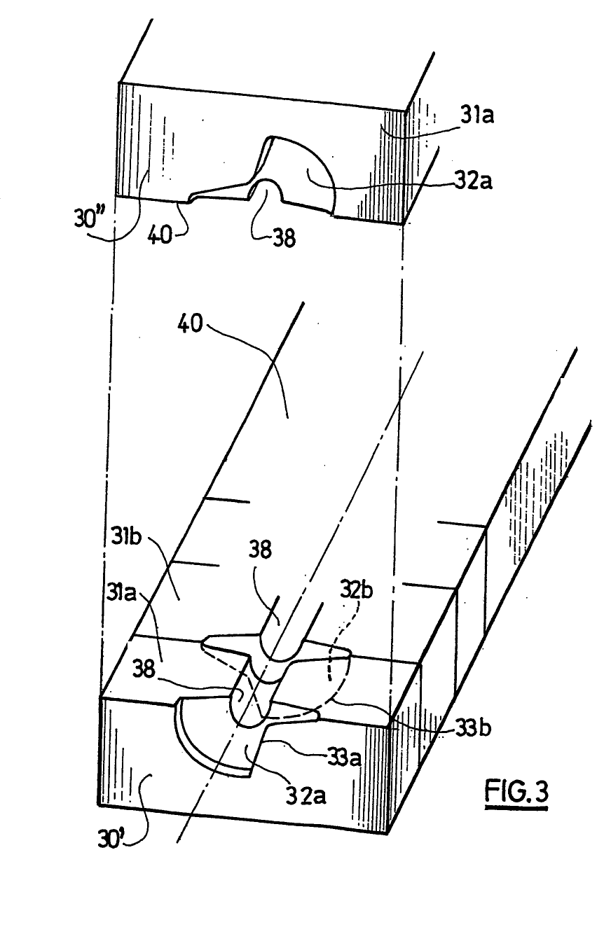

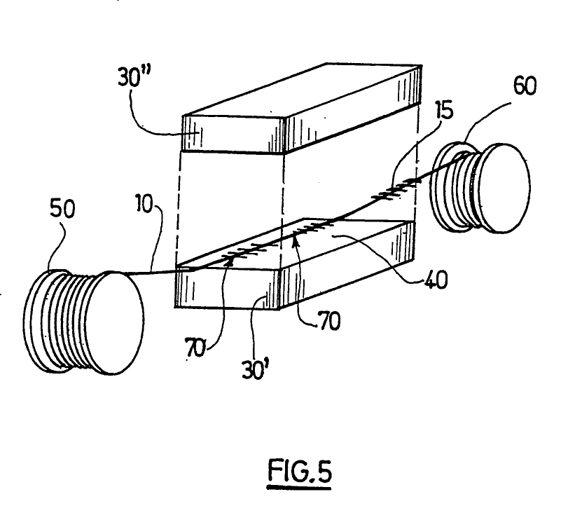

FIG. 3 shows a perspective view of elements of the mould,

FIG. 4 shows a partial axial cross-sectional view of a brush,

FIG. 5 shows the principle of manufacture and packaging of a group of channel cleaning brushes

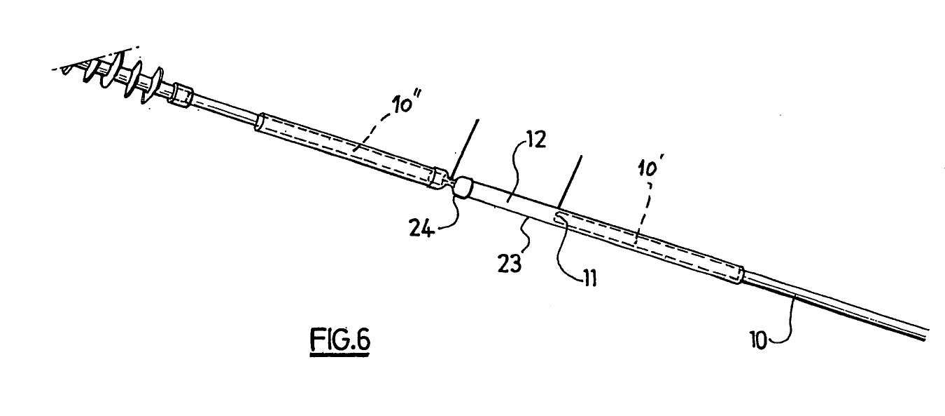

FIG. 6 shows an example of a pre-cutting segment, and

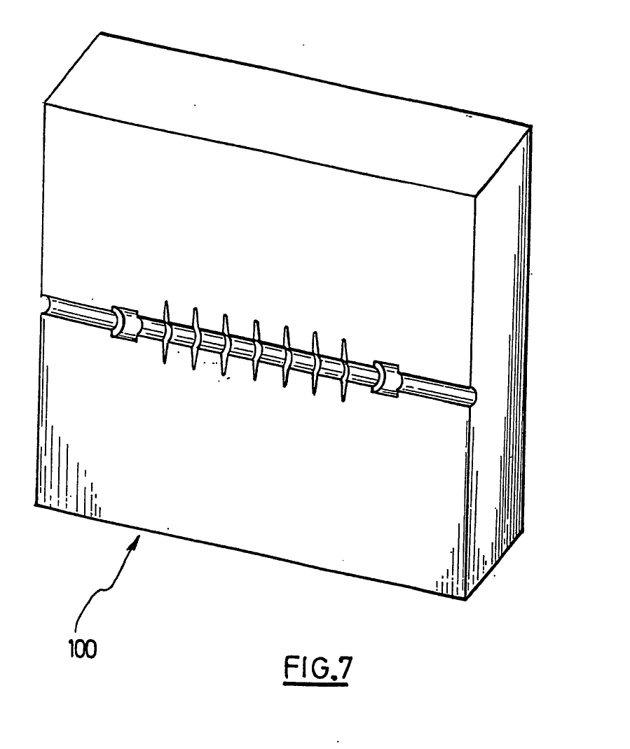

FIG. 7 shows a perspective view of an example of a half-mould.

With reference to FIG. 1, the channel cleaning brush 1 has a core 10, of synthetic material thread such as Teflon or of polytetrafluoroethylene (PTFO), which is flexible and of good mechanical quality, on which a brush 15 is attached, itself being formed by a shaft 20 bearing brushing or scraping fins 21. The brush 15 is in this case made as a single piece of moulded synthetic material, for example, low density polyethylene, the flexibility of which permits the walls of the operating channel to be brushed without damaging or deforming them.

The fins shown in FIG. 2 are of a shape covering substantially one sector, in the case of fins with only one blade, or n sectors, in the case of fins with n blades, of the transverse cross-section of the operating channel of which they are intended to scrape the walls.

FIG. 2 shows the relative placement of the fins 21, in this case in two sectors of substantially an angle_with respect to the centre, which are inscribed in a circle with a diameter D corresponding to the diameter of the section of the channel to be scraped, or a little greater, its shaft 20 to which it is attached, being of a diameter d, and the core 10 of the channel cleaning brush.

As shown in FIG. 4, which is a partial axial cross-section of a brush, the fins 21 are regularly disposed axially on the shaft 20, spaced apart from each other by a distance e which is not particularly large, for example equal to D-d.

Similarly the fins 21 are regularly disposed in an angled manner i.e. two successive fins 21 are axially rotated by an angle_in relation to each other. For this reason it is possible to refer to a cleaning coil although the fins themselves are not twisted.

In the example of FIG. 2, the angle_is equal to π/2, and the fin 21 following that shown would cover the angle β of the figure.

Thus in this example two successive fins with two blades would be sufficient to scrape the whole wall of the channel.

More generally, a brush will be formed by at least 2π/(n_) fins with n blades to cover the whole periphery of the wall.

In this case there is a preference for n=2 blades and an angle_equal to π/2, which achieves an advantage during manufacture since a single cutting plane 40 is provided, illustrated in FIGS. 2 and 4, for all the fins in their final position on the shaft of the brush.

Thus it is possible to mould the fins 21 and the shaft 20 simultaneously in order to produce a single unified piece. Moreover, a mould 30′, 30″, FIG. 5, is provided to over-mould the brushes 15 directly onto the flexible core 10 of the channel cleaning brush.

The over-moulding operation is of the fusion diecasting type in this case.

The core 10 is held taut between a supply spool 50 dispensing the PTFO thread (to serve as the core) and a receiving spool 60 receiving the formed channel cleaning brushes which are ready for dispatch. Between the two spools the mould 30′, 30″ over-moulds the brushes 15 onto the thread 10 by means of depressions 32a, 32b, FIG. 3, at locations predetermined by the advancement of the thread between the two spools and the position of the depressions in the mould. The brushes are fixed to the core in a purely thermal manner, the temperature reached during the over-moulding operation, which is effected by fusion, causing superficial melting of the PTFO thread. Pre-cutting points for the core 10 at the ends 2, 3 of the channel cleaning brushes are formed, simultaneously with the brushes at predetermined sites 70 relative to the depressions 32a, 32b in the mould, these pre-cutting points being located between two brushes (15) so that they can be separated when about to be used.

FIG. 6 shows a particular embodiment of these pre-cutting points in which the PTFO thread of the core 10 is cut at 11, the two strands 10′, 10″ are separated in order to leave a gap 12 between them, and a connector 23, itself comprising a breaking point (24) between the two strands, is over-moulded onto the two strands 10′, 10″ while preserving this gap.

Users are thereby provided with spools of channel cleaning brushes which are very easy to use.

The manufacturing tool for such a connector in the tool for manufacturing the brushes described hereinunder can easily be produced.

However, it is also necessary to provide a knife for cutting the core, pincers for grasping the two ends thus obtained and means for separating these ends by the gap 12 and positioning them on both sides of the pre-cutting point 70 of the mould, it is necessary to control all these means before the moulding operation itself.

The mould itself must comprise the depressions for these segments at the sites 70.

It would also be possible to dispense with pre-cutting segments, allowing the user to cut the channel cleaning bushes himself but this would remove one of the advantages of the invention.

In FIG. 3 the mould 30′, 30″ has two complementary blocks 30′, 30″ corresponding to two half moulds. When in contact the two blocks are separated at their contact face by a cutting plane 40, partially illustrated in FIG. 4 and indicated in FIG. 2. A block 30′ or 30″ is formed by a stack of elements 31a, 31b . . . , each element having two halves 32a, 32b each being half the thickness of a fin depression, the stacked arrangement producing the full thicknesses, and the two blocks forming the complete depressions. These two depression halves 32a, 32b are connected by a half-depression 38 for a segment of the shaft of the brush. This design requires termination elements having only half the depression thickness. It is possible to design elements (not shown) having only the complete thickness of a half-depression. The termination blocks are thus no longer necessary.

It is also possible to design (FIG. 7) half-moulds 100 which are non-modular.

For other types of fins the design of the mould would be more complex.

The process for producing the channel cleaning brushes is consequently the following: assuming that the flexible core 10 is in place in the open mould 30′, 30″, 1) the brush or brushes 15 are over-moulded onto this flexible core after having closed the two blocks 30′, 30″ one on the other, the brushes being over-moulded and at the same time thermally fixed at locations predetermined by the position of the core in the mould,

2) a pre-cutting point connector 23, 24 for the core 10 is simultaneously moulded at a predetermined location 70 on the channel cleaning brush,

3) the mould 30′, 30″ is opened and the brush or brushes 15 are demoulded,

4) the supply spool 50 is turned to unwind the core 10 with no brushes applied by a length of flexible core corresponding to a moulding operation, this length being positioned in the block 30′,

5) and the receiving spool 60 is turned simultaneously by the length of the core corresponding to the moulding operation which has just been effected to wind the core bearing the brushes by a corresponding length.

1. Process for producing a channel cleaning brush (1) for cleaning an endoscope operating channel, comprising, mounted on a flexible core (10), at least one brush (15) comprising a cleaning coil (21) disposed on a shaft (20), wherein a synthetic material brush (15) is over-moulded (30′, 30″; 100) onto the core (10), the process being characterised by the fact that a plurality of brushes (15) are over-moulded onto the core (10).

2. Process as claimed in claim 1, wherein the core (10) is pre-cut between two brushes (15).

3. Process as claimed in claim 1, wherein the core (10) is cut between two brushes (15), the two strands (10′, 10″) of the core are separated and a pre-cutting point connector (23) comprising a breaking point (24) is over-moulded onto the two strands (10′, 10″).

4. Process as claimed in any one of claims 1 to 3, wherein the core (10) with no brushes applied is unwound from a supply spool (50) and the core (10) bearing the brushes (15) is wound onto a receiving spool (60).

5. Process as claimed in any one of claims 1 to 4, wherein the over-moulding is fusion diecast moulding.

6. Process as claimed in any one of claims 1 and 5, wherein over-moulding is carried out in a modular mould (30′, 30″).
